(19) United States
(12) Patent Application Publication
(10) Pub. No.: US 2011/0061782 A1
(43) Pub. Date: Mar. 17, 2011

(54) INNER TUBE FOR A PNEUMATIC TYRE BASED ON A THERMOPLASTIC ELASTOMER

(75) Inventors: Jose Merino Lopez, Riom (FR); Pierre Lesage, Clermont-Ferrand (FR); Frederic Pialot, Moissat (FR); Michel Ahouanto, Enval (FR)

(73) Assignee: Societe De technologie Michelin, Clermont-Ferrand (FR)

(21) Appl. No.: 12/920,257

(22) PCT Filed: Mar. 10, 2009
(86) PCT No.: PCT/EP09/01693

§ 371 Date: Dec. 3, 2010

(30) Foreign Application Priority Data
Mar. 10, 2008 (FR) 0851520

(51) Int. Cl. B60C 5/04; B60C 19/12; B29C 73/16; B29D 23/24

(52) U.S. Cl. 152/503; 156/120; 156/118

(57) ABSTRACT

Inner tube for a pneumatic tyre, notably for a bicycle, characterized in that it has an elastomeric gastight layer consisting of an elastomeric composition comprising at least one styrene/isobutylene/styrene thermoplastic elastomer (called “SIBS”) and in that it includes a self-sealing material disposed inside the cavity formed by the airtight elastomeric layer.

### FIELD OF THE INVENTION

The present invention relates to an inner tube for a pneumatic tyre, notably for a bicycle, with optimum mass, airtightness and strength characteristics.

### TECHNOLOGICAL BACKGROUND

Weight is a very important parameter for bicycle users. This also applies to inner tubes. Several types of inner tube exist for bicycles, notably based on natural rubber latex and based on butyl rubber. Inner tubes made of natural rubber latex have the lowest weight. This is why these inner tubes are still marketed in spite of their more complex and costly manufacturing method, as well as their very inferior airtightness compared with inner tubes comprising butyl rubber.

Document FR 2 403 182 describes a latex inner tube having an inner covering of artificial polyisobutylene latex designed to give these latex inner tubes increased impermeability to gases. However, the manufacturing method still makes use of aqueous rubber emulsions and is long and costly.

Another disadvantage of inner tubes is their sensitivity to punctures and notably punctures connected with impacts. When an impact occurs, for example when passing over a pothole or running over an obstacle, the sides of the tyre and of the inner tube may be pinched strongly between the obstacle and the wheel rim flanges where the tyre is mounted. Sudden punctures may result. “Impact-pinching” is referred to. Damage is aggravated when the pressure for inflating the tyre is insufficient.

### DESCRIPTION OF THE INVENTION

In order to overcome these various disadvantages, the invention provides an inner tube for a pneumatic tyre, notably for a bicycle, characterized in that it has an elastomeric gastight layer consisting of an elastomeric composition comprising at least one styrene/isobutylene/styrene thermoplastic elastomer (called “SIBS”) and in that it includes a self-sealing material disposed inside the cavity formed by the airtight elastomeric layer.

Preferably, the thickness of the gastight layer for a bicycle according to the invention lies between 0.3 and 2.5 mm.

The use of an SIBS as the material making up the gastight layer of the inner tube according to the invention gives this inner tube decisive advantages compared with previously cited latex inner tubes. Indeed, the airtightness of these SIBS inner tubes is close to that of butyl inner tubes, while their mass (excluding self-sealing material) is comparable to that of current latex inner tubes. The crack propagation resistance of SIBS is also superior to that of natural rubber lattices.

The thickness of the gastight layer preferably lies between 0.4 and 0.9 mm. These thicknesses make it possible to obtain inner tubes with a mass comparable to that of current latex inner tubes while having an airtightness comparable to that of butyl inner tubes. The mass of such an inner tube may lie between 60 and 75 g (excluding self-sealing material) according to the dimensions and applications for bicycles. The presence of the self-sealing material makes it possible to continue running in more than 90% of cases of punctures.

The thickness of the gastight layer may lie between 1.2 and 2.5 mm in all cases where excellent airtightness is required for this layer. This airtightness is then completely comparable to that of usual butyl inner tubes while offering reduced hysteresis and thus reduced rolling resistance.

The inner tube according to the invention may have a substantially circular axial section.

In the present description, unless expressly indicated otherwise, all percentages (%) indicated are % by mass. In addition, any interval of values denoted by “between a and b” represents the range extending from more than a to less than b (that is to say strict limits excluding a and b) while any interval of values denoted by “from a to b” signifies the range extending from a to b (that is to say including the strict limits a and b).

The gastight elastomeric composition used according to the invention is a composition comprising at least one SIBS thermoplastic elastomer with which, according to a preferred embodiment of the invention, an extending oil may be associated as a plasticizing agent.

A “composition comprising at least one SIBS elastomer” should be understood, by definition, to mean any composition (or mixture) comprising said SIBS elastomer and at least one second component (extending oil or any other additive), as well as the SIBS elastomer taken as it is, that is to say alone (without additive).

The styrene/isobutylene/styrene elastomer (abbreviated to “SIBS”) forms, in a known manner, part of the family of thermoplastic elastomers (abbreviated to “TPE”), and more precisely thermoplastic styrene elastomers (abbreviated to “TPS”).

It will be recalled here that TPS elastomers are generally in the form of styrene-based block copolymers. With a structure intermediate between thermoplastic and elastomeric polymers, they consist of rigid polystyrene sequences linked by flexible elastomeric sequences, for example polybutadiene, polyisoprene, poly(ethylene/butylene), or polyisobutylene in the case for example of SIBS. These are often triblock elastomers with two rigid segments linked by a flexible segment. The rigid and flexible segments may be disposed linearly, in the shape of a star or branched. Typically, each of these segments or blocks contains a minimum of more than 5, generally more than 10, base units (for example styrene and isobutylene for SIBS).

According to one preferred embodiment of the invention, the amount by weight of styrene in the SIBS elastomer lies between 5% and 50%. Below the indicated minimum, the thermoplastic nature of the elastomer risks falling substantially while above the recommended maximum, the elasticity of the composition may be affected. For these reasons, the amount of styrene is more preferably between 10 and 40%, particularly between 15 and 35%.

Styrene should be understood, in the present description, as any unsubstituted as well as substituted styrene-based monomer. Among substituted styrenes mention may be made for example of methylstyrenes (for example α-methylstyrene, β-methylstyrene, p-methylstyrene, tert-butylstyrene) and chlorostyrenes (for example monochlorostyrene and dichlorostyrene).

It is preferable for the glass transition temperature (Tg, measured according to ASTM D3418) of the SIBS elastomer to be below −20° C., more preferably below −40° C. A Tg value above these minima, implying a higher Tg for the composition itself, may reduce the performance of the composition when used at a very low temperature. For such a use, the Tg of the SIBS elastomer is preferably even below −50° C.

The number-average molecular mass (referred to as Mn) of the SIBS elastomer preferably lies between 30 000 and 500 000 g/mol, more preferably between 40 000 and 400 000 g/mol. Below the indicated minima, there is a risk of the cohesion between the SIBS elastomer chains being affected, notably by reason of its possible dilution (i.e. the presence of an extending oil); and on the other hand an increase in the temperature of use risks affecting the mechanical properties, notably fracture properties, with consequently reduced “hot” performance. In addition, too high an Mn mass may adversely affect the flexibility of the composition. It was thus found that a value within a range of 50 000 to 300 000 was particularly well suited, notably for use of the composition in a bicycle inner tube.

The number-average molecular mass (Mn) of the SIBS elastomer is determined in a known manner by steric exclusion chromatography (SEC). The sample is previously dissolved in tetrahydrofuran at a concentration of approximately 1 g/l and the solution is filtered through a filter with a porosity of 0.45 μm before injection. The apparatus used is a “WATERS alliance” chromatography line. The eluting solvent is tetrahydrofuran, the flow rate 0.7 ml/min, the temperature of the system 35° C. and the duration of analysis 90 min. A set of four WATERS columns is used in series, with trade names “STYRAGEL” (“HMW7”, “HMW6E” and two “HT6E”). The volume injected of the polymer sample solution is 100 μl. The detector is a “WATERS 2410” differential refractometer and its associated software for processing the chromatographic data is a “WATERS MILLENIUM” system. The calculated average molecular masses are relative to a calibration curve prepared with polystyrene standards.

The polydispersity index Ip (it may be recalled that: Ip=Mw/Mn with Mw weight-average molecular mass) of the SIBS elastomer is preferably less than 3 and more preferably Ip is less than 2.

The SIBS elastomer may make up the entire elastomer matrix or, if as the case may be other elastomers are used, preferably make up the majority of the elastomer (by weight). In such a case, the SIBS elastomer preferably represents more than 50% and even more preferably more than 70% by weight of all the elastomers. Such complementary elastomers, preferably in minor amounts, could for example be diene elastomers such as natural rubber or a synthetic polyisoprene, a butyl rubber or thermoplastic styrene elastomers (TPS) other than SIBS, within the compatibility limit of their microstructures.

As a TPS elastomer other than SIBS that may be used as a complement to SIBS previously described, mention may be notably made of a TPS elastomer chosen from the group consisting of styrene/butadiene/styrene block copolymers, styrene/isoprene/styrene block copolymers, styrene/isoprene/butadiene/styrene block copolymers, styrene/ethylene/butylene/styrene block copolymers, styrene/ethylene/propylene/styrene block copolymers, styrene/ethylene/ethylene/propylene/styrene block copolymers and mixtures of these copolymers. More preferably, said complementary TPS elastomer that may be used is chosen from the group consisting of styrene/ethylene/butylene/styrene block copolymers, styrene/ethylene/propylene block copolymers and mixtures of these copolymers.

However, according to a preferred embodiment, the SIBS elastomer is the only elastomer and the only thermoplastic elastomer present in the elastomeric composition of the gastight layer of the inner tube.

SIBS elastomers may be employed conventionally for TPEs, by extrusion or moulding, for example from a raw material available in the form of beads or granules. They are commercially available, sold for example by Kaneka under the name “SIBSTAR” (e.g. “Sibstar 102T”, “Sibstar 103T” or “Sibstar 073T”).

They are for example described, as well as their synthesis, in patent documents EP 731 112, U.S. Pat. No. 4,946,899 and U.S. Pat. No. 5,260,383. They were first of all developed for biomedical applications and then described in various applications specific to TPE elastomers, as varied as medical equipment, automobile parts and parts for domestic electrical appliances, electric wire sheathing, and sealing or elastic parts (see for example EP 1 431 343, EP 1 561 783, EP 1 566 405, WO 2005/103146).

However, to the knowledge of the Applicants, no document of the state of the art describes or suggests their use in a pneumatic object such as a bicycle inner tube where this product has been revealed, quite unexpectedly, to be able to compete with conventional formulations based on butyl rubber and latex.

The SIBS elastomer previously described is sufficient on its own for fulfilling the function of gastightness in relation to pneumatic objects in which it is used.

However, according to one preferred embodiment of the invention, the elastomeric composition also includes, as a plasticizing agent, an extending oil (or plasticizing oil) of which the function is to adjust the modulus to requirements, at the cost however of a certain loss of airtightness.

Any extending oil, preferably with a slightly polar character, capable of extending and plasticizing elastomers, notably thermoplastic elastomers, may be used. At ambient temperature (23° C.), these relatively viscous oils are liquid (namely, it should be remembered, substances having the capacity in time to take the shape of their container), as against notably resins that are solid by nature.

The extending oil is preferably chosen from the group consisting of polyolefinic oils (namely those from the polymerization of olefins, monoolefins or diolefins), paraffinic oils, naphthenic oils (with a high or low viscosity), aromatic oils, mineral oils and mixtures of these oils.

It should be noted that the addition of an extending oil to SIBS brings about a loss of airtightness in the latter, which varies according to the type and quantity of oil used. An oil of the polybutene type is preferably used, in particular a polyisobutylene oil (abbreviated to “PIB”), that has demonstrated the best compromise in properties compared with other oils tested, notably a conventional oil of the paraffinic type.

As examples, polyisobutylene oils are marketed notably by Univar under the name “Dynapak Poly” (e.g. “Dynapak Poly 190”), by BASF under the names “Glissopal” (e.g. “Glissopal 1000”) or “Oppanol” (e.g. “Oppanol B12”). Paraffinic oils are marketed for example by Exxon under the name “Telura 618” or by Repsol under the name “Extensol 51”.

The number-average molecular mass (Mn) of the extending oil preferably lies between 200 and 25 000 g/mol, more preferably still between 300 and 10 000 g/mol. For too low Mn masses, a risk exists of oil migrating outside the composition, while too high masses may make this composition excessively rigid. A mass Mn of between 350 and 4 000 g/mol, in particular between 400 and 3 000 g/mol, has proved to constitute an excellent compromise for the application concerned.

The number-average molecular mass (Mn) of the extending oil is determined by SEC, the sample being previously dissolved in tetrahydrofuran at a concentration of approximately 1 g/l. The solution is then filtered on a filter with a porosity of 0.45 μm before injection. The apparatus is a “WATERS Alliance” chromatography line. The eluting solvent is tetrahydrofuran, the flow rate 1 ml/min, the temperature of the system 35° C. and the duration of analysis 30 min. A set of two “WATERS” columns called “STYRAGEL HT6E” is used. The volume injected of the polymer sample solution is 100 μl. The detector is a “WATERS 2410” differential refractometer and its associated software for processing the chromatographic data is the “WATERS MILLENIUM” system. The average molar masses calculated are relative to a calibration curve prepared with polystyrene standards.

A person skilled in the art will know, in the light of the description and the following examples of embodiments, how to adjust the quantity of extending oil according to the particular conditions under which the composition is used.

It is preferable for the amount of extending oil to be greater than 5 phr, preferably between 5 and 100 phr (phr signifies parts by weight per hundred parts of the total elastomer, SIBS and any other elastomer that may be present in the composition).

Below the minimum indicated, there is a risk of the elastomeric composition having too high a rigidity for some applications while, above the recommended maximum, there is the risk of being exposed to insufficient cohesion of the composition and loss of airtightness that may be harmful according to the application considered.

For these reasons, in particular for use of the airtight composition as a bicycle inner tube, it is preferable for the amount of extending oil to be greater than 10 phr, notably between 10 and 90 phr and still more preferably greater than 20 phr, notably between 20 and 80 phr.

The airtight composition may also include various additives usually present in inner tubes known to a person skilled in the art. Mention may be made for example of reinforcing fillers such as carbon black or silica, non-reinforcing or inert fillers, colouring agents that may advantageously be used for colouring the composition, flaky fillers improving airtightness still further (e.g. phyllosilicates such as kaolin, talc, mica, graphite, clays or modified clays (“organoclays”), plasticizing resins, tackifying resins, protective agents such as antioxidants or anti-ozone agents, anti-UV agents, or various processing agents and other stabilizers.

Apart from the previously described elastomers (SIBS and other elastomers that may be present), the gastight composition could also contain, still in a minor weight fraction relative to the SIBS elastomer, polymers other than elastomers, such as for example thermoplastic polymers compatible with the SIBS elastomer.

The previously described gastight composition is a solid compound (at 23° C.) and is elastic, which is notably characterized, by virtue of its specific formulation, by very high flexibility and very high deformability.

According to one preferred embodiment of the invention, this gastight composition has a secant modulus in extension, at 10% elongation (referred to as M10), that is less than 2 MPa, more preferably less than 1.5 MPa, notably less than 1 MPa. This quantity is measured in a first elongation (that is to say without an accommodation cycle) at a temperature of 23° C., with a traction rate of 500 mm/min (ASTM standard D412), and relative to the initial cross section of the specimen.

According to one advantageous embodiment, the self-sealing material disposed in the inner cavity of the inner tube formed by the gastight layer may be a viscous liquid containing at least one of the constituents chosen from the group consisting of glycol, fibres, vulcanized rubber particles, particles of cellular material and mixtures thereof. It also advantageously uses a non-aqueous matrix. The viscosity of this material is preferably less than 60 centipoise at 20° C.

Such an inner tube with a self-sealing material is heavier (the quantity of self-sealing material to be introduced is of the order of 50 to 80 g) but has the advantage of being able to continue running in more than 90% of cases of punctures.

The object of the invention is also a method for producing the inner tube according to the invention, comprising the following steps:

a tube is made with the gastight elastomeric composition;

an inflating valve is attached;

a given quantity of self-sealing material is introduced into the tube; and

an overlapping end weld is made.

The tube may be made by extrusion or extrusion/blow moulding. It may also be made by injection moulding.

According to another embodiment, the self-sealing material consists of a layer of a second composition comprising, as the major elastomer, a thermoplastic styrene elastomer (abbreviated to “TPS”), which is identical to or different from SIBS, and an oil for extending the TPS elastomer in an amount greater than 200 phr.

The amount of oil for extending the TPS elastomer is advantageously less than 1200 phr.

The inner tube according to the invention then consists of two layers, each comprising a thermoplastic elastomer; the first, disposed externally, has the function of ensuring the gastightness of the inner tube, and the second, disposed internally, provides a self-sealing function in the case where the inner tube is punctured.

The first step in the production of an inner tube according to the invention may very advantageously be carried out by coextruding the two thermoplastic elastomeric compositions.

The TPS elastomer is preferably chosen from the group consisting of styrene/butadiene/styrene, styrene/isoprene/styrene (SIS), styrene/isoprene/butadiene/styrene, styrene/ethylene/butylene/styrene (SEBS), styrene/ethylene/propylene/styrene (SEPS), styrene/ethylene/ethylene/propylene/styrene block copolymers and mixtures of these copolymers.

More preferably, said elastomer is chosen from the group consisting of SEBS copolymers, SEPS copolymers and mixtures of these copolymers.

According to another preferred embodiment of the invention, the amount of styrene in the TPS elastomer lies between 5 and 50%.

Below the indicated minimum, there is a risk of the thermoplastic nature of the elastomer being substantially reduced while, above the recommended maximum, the elasticity of the composition may be affected. For these reasons, the amount of styrene is more preferably between 10 and 40%, in particular between 15 and 35%.

It is preferable for the glass transition temperature (Tg, measured according to ASTM D3418) of the TPS elastomer to be below −20° C., more preferably below −40° C.

A Tg value above these minima, implying a higher Tg of the self-sealing composition itself, may reduce the performance of the self-sealing composition when used at a very low temperature. For such a use, the Tg of the TPS elastomer is even more preferably below −50° C.

The number-average molecular mass (referred to as Mn) of the TPS elastomer preferably lies between 50 000 and 500 000 g/mol, more preferably between 75 000 and 450 000 g/mol. Below the indicated minima, there is a risk of the cohesion between the TPS elastomer chains being affected, by reason of its dilution (quantity of extending agent). Moreover, an increase in the temperature of use risks affecting the mechanical properties, notably the fracture properties, consequently with reduced “hot” performance. In addition, too high a mass Mn may harm the flexibility of the composition at the recommended amounts of extending oil. Thus, it was found that a value within a range of 250 000 to 400 000 g/mol was particularly well suited, notably for use of the self-sealing composition in a bicycle inner tube.

The TPS elastomer may make up all the elastomeric matrix or the major part by weight (preferably for more than 50%, more preferably for more than 70%) of the latter when it comprises one or more other elastomers, whether thermoplastic or not, for example of the diene type.

According to one preferred embodiment, the TPS elastomer is the only elastomer and the only thermoplastic elastomer present in the self-sealing composition.

The second essential constituent of the self-sealing composition is an extending oil (or plasticizing oil) used at a very high level.

Any extending oil, preferably with a weakly polar character, which is able to extend and plasticize elastomers, notably thermoplastic elastomers, may be used.

The extending oil is preferably chosen from the group consisting of polyolefinic oils (namely derived from the polymerisation of olefins, monoolefins or diolefins), paraffinic oils, naphthenic oils (with a low or high viscosity), aromatic oils, mineral oils, and mixtures of these oils.

More preferably, the extending oil is chosen from the group consisting of polybutenes, paraffinic oils and mixtures of these oils. A polyisobutene oil is very particularly used, in particular polyisobutylene (PIB).

The number-average molecular mass (Mn) of the extending oil preferably lies between 200 and 30 000 g/mol, even more preferably between 300 and 10 000 g/mol.

For too low Mn masses, there is a risk of the oil migrating outside the self-sealing composition, while too high masses may make this composition excessively rigid. An Mn mass of between 350 and 4 000 g/mol, in particular between 400 and 3 000 g/mol, has proved to constitute an excellent compromise for the applications concerned, in particular for use in a bicycle inner tube.

The amount of extending oil is preferably between 300 and 700 phr. Below the indicated minimum, there is a risk of the self-sealing composition having too high a rigidity for some applications while, above the recommended maximum, there is a risk of insufficient cohesion of the composition.

The two previously described constituents, namely the TPS elastomer and the extending oil, are sufficient on their own for the self-sealing composition to fulfil its anti-puncture function totally in relation to pneumatic objects in which it is used.

However, various other additives may be added, typically in a small quantity (preferably in amounts less than 20 phr, more preferably less than 10 phr), such as for example reinforcing fillers such as carbon black, non-reinforcing or inert fillers, flaky fillers, protective agents such as anti-UV agents, antioxidants or anti-ozone agents and various other stabilizers and colouring agents that may be advantageously used for colouring the self-sealing composition.

Although the self-sealing composition, by virtue of its specific composition, does not require the use of a tackifying resin (it may be remembered that this is a resin capable of giving “tack”, that is to say immediate adhesion with light pressure on a support), the invention also applies to the cases where such a tackifying resin would be used, in this case preferably in a minor proportion, typically less than 100 phr, more preferably less than 50 phr (for example between 0 and 20 phr).

Other than the elastomers (TPS and any other elastomers) previously described, the self-sealing composition could also include, still in a minor fraction by weight relative to the TPS elastomer, polymers other than elastomers, such as for example thermoplastic polymers compatible with the TPS elastomer.

The self-sealing composition or material previously described is a solid compound (at 23° C.) and is elastic, which is characterized notably, by virtue of its specific formulation, by very high flexibility and very high deformability.

According to one particular embodiment of the invention, the self-sealing composition has an elongation at break greater than 500%, more preferably greater than 800%, and a breaking stress greater than 0.2 MPa, these two quantities being measured in a first elongation (namely without an accommodation cycle) at a temperature of 23° C., with a traction rate of 500 mm/min (ASTM standard D412), and relative to the initial cross section of the specimen.

TPS elastomers such as SEPS or SEBS extended with large amounts of oils are well known and are available commercially in the extended form. As examples, mention may be made of products marketed by Vita Thermoplastic Elastomers or VTC (“VTC TPE group”) under the name “Dryflex” (e.g. “Dryflex 967100”) or “Mediprene” (e.g. “Mediprene 500 000M”), or those sold by Multibase under the name “Multiflex” (e.g. “Multiflex G00”).

These products, developed notably for medical, pharmaceutical or cosmetic applications, may be employed in a conventional manner for TPEs, by extrusion or moulding, for example from a raw material available in the form of beads or granules.

Entirely surprisingly, they have proved capable, after any adjustment if necessary in the amount of their extending oil within the range recommended by the present invention (namely between 200 and 1200 phr, preferably between 300 and 700 phr), of fulfilling the function of an efficient self-sealing composition.

The thickness of the anti-puncture layer for inner tubes for bicycle tyres is preferably greater than 0.3 mm. When the total mass of inner tube is of importance, the thickness is more preferably between 0.4 and 1 mm. When resistance to impacts-pinching is of importance, the thickness is more preferably between 1.2 and 2.5 mm.

The layer of self-sealing material may be disposed on part of the inner wall of the gastight layer and on the side of the larger diameters of said wall. This makes it possible to limit the weight of this layer and very satisfactorily protect against punctures through the top of the tyre.

The layer of self-sealing material may also be disposed on part of the inner wall of the SIBS elastomeric composition, and at least from one equator to the other while passing through the largest diameters. It may also be disposed on the entire inner wall of the SIBS elastomeric composition.

The extension of the layer of self-sealing material in these last two embodiments brings about a very valuable advantage, namely that of reinforcing the strength of all the tyre and inner tube against punctures associated with impacts-pinching. In this case, the walls of the sides of the tyre and of the inner tube may be strongly pinched against the wheel rim flanges which may cause punctures. The presence of the self-sealing layer protects the tyre and inner tube very effectively from punctures.

The object of the invention is also a method for producing an inner tube, comprising the following steps:
a tube is made by coextruding a first elastomeric composition comprising at least one styrene/isobutylene/styrene thermoplastic elastomer (SIBS) and a second elastomeric composition comprising a thermoplastic styrene elastomer (TPS), which is identical to or different from SIBS, and an oil for extending the TPS elastomer in an amount greater than 200 phr; and
the inner cavity of the tube is closed.

According to a first embodiment, the cavity of the tube may be closed by welding the two ends of the tube. An airtight self-sealing inner tube is thus obtained in which the two ends are welded and that may be easily put in place without always having to remove the tyre from the wheel. Its production is also facilitated.

According to a second embodiment, the cavity of the tube may be closed by making an overlap end weld. This conventional method gives an inner tube with a toric form.

An inflating valve may be attached before the inner cavity of the tube is closed.

### BRIEF DESCRIPTION OF THE DRAWINGS

All the implementing details are given in the following description supplemented by the following figures:

FIG. 1 shows a partial axial section of an inner tube according to the invention;

FIG. 2 shows an inner tube containing a liquid self-sealing material;

FIG. 3 shows an inner tube containing a layer of elastomeric thermoplastic self-sealing material; and

FIG. 4 shows an inner tube comprising a layer of elastomeric thermoplastic self-sealing material extending over the entire inner wall of the SIBS elastomer.

### DETAILED DESCRIPTION OF EMBODIMENTS OF THE INVENTION

An “axial section” of an inner tube is understood to mean a section passing through the axis of rotation of the inner tube.

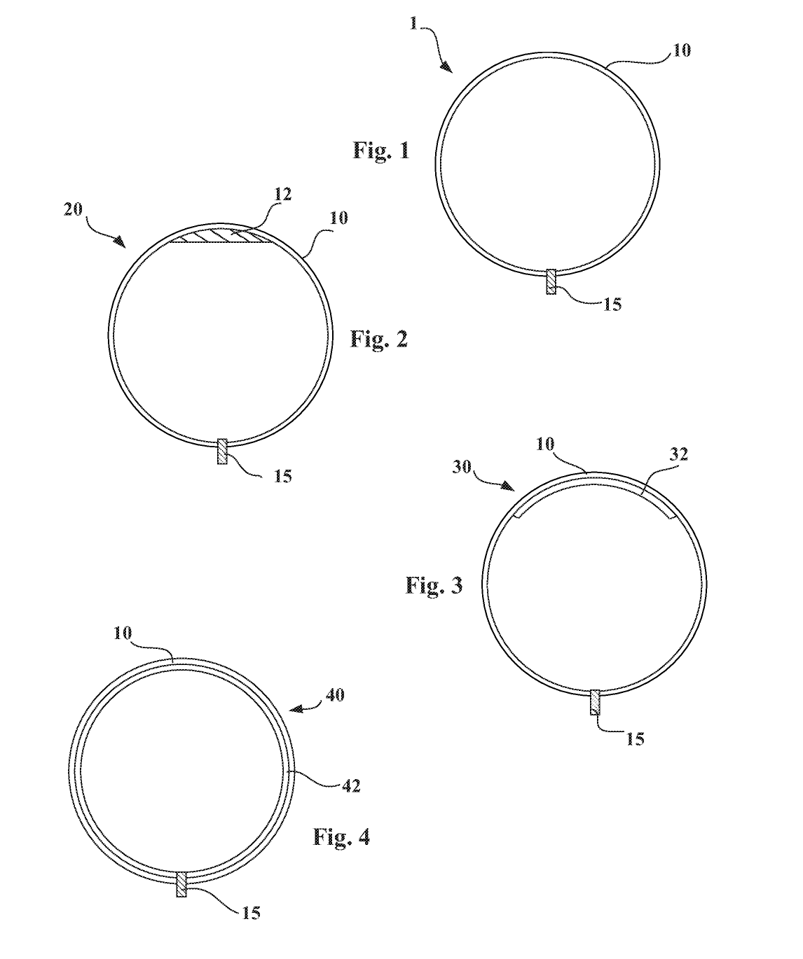

FIG. 1 shows an inner tube 1 according to the invention in partial axial section. This inner tube 1 comprises a closed torus 10 with an annular axial section constituting a layer of a thermoplastic elastomeric composition made of SIBS as well as an inflating valve 15.

Contrary to a conventional inner tube using a composition based on latex or butyl rubber, the inner tube according to the invention uses for example as an airtight layer 10 an SIBS elastomer (“Sibstar102T” with an amount of styrene of approximately 15%, Tg approximately −65° C. and Mn approximately 90 000 g/mol) that is not extended. Such an inner tube has a modulus M10 of the order of 1.4 MPa and an airtightness comparable to that of a usual composition for a butyl-based inner tube. This makes it possible to limit its thickness to approximately 0.4 mm, its weight thus being at a minimum.

Such an inner tube is made simply by extruding a tube, attaching an inflating valve and then making an overlap weld.

FIG. 2 shows an inner tube 20 similar to that of FIG. 1, in which a self-sealing liquid material 12 is introduced. When running, this liquid is distributed over the side of the inner tube with a maximum diameter by reason of centrifugal forces. This is shown in the figure.

Such a self-sealing liquid may for example be Sealtite Pro manufactured by Sparty Systems, LLC. This self-sealing product mainly comprises water and ethylene glycol as well as ceramic fibres to stop up punctures. Another example of a self-sealing product is described in the document WO2006002039 A2.

An inner tube 30 according to the invention is shown in FIG. 3 in which a layer 32 of a self-sealing thermoplastic elastomeric composition is added. This layer is disposed on the inner wall of the gastight layer 10 of the inner tube 30. The layer 32 is disposed only on the side of the highest radii of the inner tube. This makes it possible to limit the total weight of the latter while obtaining excellent resistance to punctures at the top of a tyre equipped with the inner tube 30.

An inner tube 40 is shown in FIG. 4 in which a layer 42 of a self-sealing thermoplastic elastomeric composition is added. In this embodiment, the layer 42 extends over the entire inner wall of the layer 10. This embodiment has a higher weight but exhibits a clear improvement in the resistance of the tyre and inner tube assembly to damage associated with impact and pinching of the sides against the rims.

The layers 32 and 42 may consist of an SEBS extended with of the order of 400 phr by mass of a paraffinic extending oil. This material is marketed under the name “Multiflex G00”.

Preferably, the layer 10 of the inner tubes 30 and 40 is composed of a thermoplastic elastomeric composition comprising an SIBS (“Sibstar102T”) extended with approximately 55 phr of PIB oil (“Dynapak Poly 190”—Mn of the order of 1000 g/mol). Such a layer 10 has a modulus M10 of less than 1 MPa and an airtightness of the order of 60 to 70% of a butyl inner tube composition with the same thickness.

The presence of PIB-based extending oil has the advantage of improving the tack of the layer and in this way facilitates manufacture of the inner tube. This manufacture may notably be carried out by coextruding a tube and then attaching an inflating valve 15 and performing an end weld or by welding the two ends.

The invention is not limited to the examples described and shown and various modification may be provided thereto without departing from its scope as defined by the appended claims.

1. Inner tube for a pneumatic tyre, comprising:
an airtight elastomeric layer formed of an elastomeric composition that includes at least one styrene/isobutylene/styrene thermoplastic elastomer (called “SIBS”) (SIBS elastomer); and in that it includes
a self-sealing material disposed inside a cavity formed by the airtight elastomeric layer.

2. Inner tube according to claim 1, wherein a thickness of the airtight elastomeric layer lies between 0.3 and 2.5 mm.

3. Inner tube according to claim 2, wherein the thickness of the airtight elastomeric layer lies between 0.4 and 0.9 mm.

4. Inner tube according to claim 2, wherein the thickness of the airtight elastomeric layer lies between 1.2 and 2.5 mm.

5. Inner tube according to claim 1 wherein the pneumatic tyre has a substantially circular axial section.

6. Inner tube according to claim 1, wherein the at least one SIBS elastomer includes between 5 and 50% by mass of styrene.

7. Inner tube according to claim 1, wherein a glass transition temperature (Tg) of the SIBS elastomer is below −20° C.

8. Inner tube according to claim 1, wherein a number-average molecular mass (Mn) of the SIBS elastomer lies between 30 000 and 500 000 g/mol.

9. Inner tube according to claim 1, wherein the elastomeric composition of the airtight elastomeric layer includes an extending oil.

10. Inner tube according to claim 9, wherein the extending oil is chosen from a group that includes polyolefinic oils, paraffinic oils, naphthenic oils, aromatic oils, mineral oils, and mixtures of these oils.

11. Inner tube according to claim 9, wherein the extending oil is chosen from a group that includes polybutenes.

12. Inner tube according to claim 9, wherein the extending oil is a polyisobutylene oil.

13. Inner tube according to claim 9, wherein a number-average molecular mass (Mn) of the extending oil lies between 200 and 25 000 g/mol.

14. Inner tube according to claim 9, wherein an amount of the extending oil is greater than 5 phr (phr signifying parts by weight per hundred parts of elastomer).

15. Inner tube according to claim 1, wherein the self-sealing material is a viscous liquid.

16. Inner tube according to claim 15, wherein the self-sealing material includes at least one constituent chosen from a group that includes glycol, fibres, vulcanized rubber particles, particles of cellular material, and mixtures thereof.

17. Inner tube according to claim 1, wherein the self-sealing material includes a non-aqueous fluid matrix.

18. Inner tube according to claim 15, wherein the self-sealing material has a viscosity of less than 60 centipoise at 20° C.

19. Method for producing an inner tube, comprising steps of:
forming a tube using a gastight elastomeric composition that includes at least one styrene/isobutylene/styrene thermoplastic elastomer (SIBS elastomer);
attaching an inflating valve to the tube;
introducing a predetermined quantity of self-sealing material into a cavity of the tube; and
forming an overlapping end weld.

20. Method according to claim 19, wherein the forming of the tube is by extrusion or extrusion/blow moulding.

21. Method according to claim 19, wherein the forming of the tube is by injection moulding.

22. Inner tube according to claim 1, wherein the self-sealing material is formed of a layer of a second composition that includes, as a major elastomer, a thermoplastic styrene elastomer (TPS elastomer), which is identical to or different from the SIBS elastomer, and an oil for extending the TPS elastomer in an amount greater than 200 phr.

23. Inner tube according to claim 22, wherein the amount of the oil for extending the TPS elastomer is less than 1200 phr.

24. Inner tube according to claim 22, wherein the TPS elastomer is chosen from a group that includes styrene/butadiene/styrene copolymers, styrene/isoprene/styrene copolymers, styrene/isoprene/butadiene/styrene copolymers, styrene/ethylene/butylene/styrene (SEBS) copolymers, styrene/ethylene/propylene/styrene (SEPS) copolymers, styrene/ethylene/ethylene/propylene/styrene block copolymers, and mixtures of these copolymers.

25. Inner tube according to claim 24, wherein the TPS elastomer is chosen from a group of that includes SEBS copolymers, SEPS copolymers, and mixtures of these copolymers.

26. Inner tube according to claim 22, wherein the TPS elastomer includes between 5 and 50% by mass of styrene.

27. Inner tube according to claim 22, wherein a glass transition temperature (Tg) of the TPS elastomer is below −20° C.

28. Inner tube according to claim 22, wherein a number-average molecular mass (Mn) of the TPS elastomer lies between 50 000 and 500 000 g/mol.

29. Inner tube according to claim 22, wherein the oil for extending the TPS elastomer is chosen from a group that includes polyolefinic oils, paraffinic oils, naphthenic oils, aromatic oils, mineral oils, and mixtures of these oils.

30. Inner tube according to claim 22, wherein the oil for extending the TPS elastomer is chosen from a group that includes polybutenes, paraffinic oils, and mixtures thereof.

31. Inner tube according to claim 22, wherein the oil for extending the TPS elastomer is a polyisobutylene oil.

32. Inner tube according to claim 22, wherein a number-average molecular mass (Mn) of the oil for extending the TPS elastomer lies between 200 and 30 000 g/mol.

33. Inner tube according to claim 22, wherein the amount of the oil for extending the TPS elastomer lies between 300 and 700 phr.

34. Inner tube according to claim 22, wherein a thickness of the airtight elastomeric layer lies between 0.3 mm and 2.5 mm.

35. Inner tube according to claim 22, wherein the self-sealing material is disposed on part of an inner wall of the airtight elastomeric layer on a side with a largest diameter of the inner wall.

36. Inner tube according to claim 22, wherein the self-sealing material is disposed on part of an inner wall of the airtight elastomeric layer at least from one equator to another passing on a side with largest diameter of the inner wall.

37. Inner tube according to claim 22, wherein the self-sealing material is disposed on an entire inner wall of the airtight elastomeric layer.

38. Method for producing an inner tube, comprising steps of:
forming a tube by coextruding:
a first elastomeric composition including at least one styrene/isobutylene/styrene thermoplastic elastomer (SIBS), and
a second elastomeric composition including a thermoplastic styrene elastomer (TPS), which is identical to or different from SIBS, and an oil for extending the TPS in an amount greater than 200 phr; and
closing an inner cavity of the tube.

39. Method according to claim 38, wherein the inner cavity of the tube is closed by welding two ends of the tube.

40. Method according to claim 38, wherein the inner cavity of the tube is closed by making an overlap end weld.

41. Method according to claim 38, further comprising a step of attaching an inflating valve to the tube before the inner cavity of the tube is closed.

42. Inner tube according to claim 22, wherein a glass transition temperature (Tg) of the TPS elastomer is below −40° C.

43. Inner tube according to claim 9, wherein an amount of the extending oil is greater than 5 and less than 100 phr (phr signifying parts by weight per hundred parts of elastomer).
